(19) United States
(12) Patent Application Publication
(10) Pub. No.: US 2026/0034389 A1
(43) Pub. Date: Feb. 5, 2026

(54) REUSABLE BREAKAWAY ACCESSORY KEEPER FOR HARNESS WEBBING

(71) Applicant: WERNER CO., ITASCA, IL (US)

(72) Inventors: Tracee Leonardson, Ashtabula, OH (US); Kendal King, Mars, PA (US); Cody Rappoport, Greenville, PA (US)

(73) Assignee: WERNER CO., ITASCA, IL (US)

(21) Appl. No.: 19/286,634

(22) Filed: Jul. 31, 2025

Related U.S. Application Data
(60) Provisional application No. 63/678,135, filed on Aug. 1, 2024.

(51) Int. Cl. A62B 35/00

(52) U.S. Cl. CPC A62B 35/0025

(57) ABSTRACT

A reusable breakaway accessory keeper includes a base structured to attach to webbing, a loop having a first end extending from the base, and an attachment mechanism structured to releasably attach a second end of the loop to the base, wherein the loop is structured to form a closed loop when the second end of the loop is attached to the base and to open the closed loop when the second end of the loop is released from the base.

### CROSS REFERENCE TO RELATED APPLICATIONS

This application claims priority to U.S. Provisional Patent Application Ser. No. 63/678,135, filed on Aug. 1, 2024, and titled “REUSABLE BREAKAWAY ACCESSORY KEEPER FOR HARNESS WEBBING” the disclosure of which is incorporated herein by reference.

### FIELD OF THE INVENTION

The disclosed concept relates generally to accessories for harnesses in fall protection systems, and in particular, to a reusable breakaway accessory keeper for use with a harness in fall protection systems.

### BACKGROUND OF THE INVENTION

In fall protection systems, a worker typically wears a harness. Often there is a need to secure various worker accessories or other objects. Some harnesses have fixed attachment points where accessories may be attached. For example, a tool or a lanyard may be attached to the attachment point. The tool or lanyard is then conveniently accessible to the worker. However, attaching additional items to a harness can present a risk such as the item becoming snagged on an object and hindering the worker's ability to move freely. To address the issue of an item becoming snagged, some attachment point will break under sufficient force so as to release the item attached at the attachment point and allow the worker to then move freely. However, after the attachment point breaks it is no longer usable and would need to be replaced.

There is room for improvement in accessory keepers.

### SUMMARY OF THE INVENTION

In accordance with an aspect of the disclosed concept, a reusable breakaway accessory keeper comprises: a base structured to attach to webbing; a loop having a first end extending from the base; and an attachment mechanism structured to releasably attach a second end of the loop to the base, wherein the loop is structured to form a closed loop when the second end of the loop is attached to the base and to open the closed loop when the second end of the loop is released from the base.

In accordance with an aspect of the disclosed concept, a reusable breakaway accessory keeper comprises: a base structured to attach to webbing; a loop having a first end extending from the base; and an attachment mechanism structured to releasably attach a second end of the loop to the base, wherein the base, the loop, and the attachment mechanism are formed together as a single structure.

In accordance with an aspect of the disclosed concept, a safety harness comprises: webbing; a reusable breakaway accessory keeper attached to the webbing, the reusable breakaway accessory keeper comprising: a base structured to attach to the webbing; a loop having a first end extending from the base; and an attachment mechanism structured to releasably attach a second end of the loop to the base, wherein the loop is structured to form a closed loop when the second end of the loop is attached to the base and to open the closed loop when the second end of the loop is released from the base.

### BRIEF DESCRIPTION OF THE DRAWINGS

A full understanding of the invention can be gained from the following description of the preferred embodiments when read in conjunction with the accompanying drawings in which:

FIG. 1 is a view of a reusable breakaway accessory keeper in accordance with an example embodiment of the disclosed concept;

FIG. 2 is a view of a reusable breakaway accessory keeper in accordance with another example embodiment of the disclosed concept;

FIG. 3 is a top view of the reusable breakaway accessory keeper of FIG. 2;

FIG. 4 is a side view of the reusable breakaway accessory keeper of FIG. 2;

FIG. 5 is a view of a harness including the reusable breakaway accessory keeper of FIG. 2;

FIG. 6 is another view of a harness including the reusable breakaway accessory keeper of FIG. 2;

FIG. 7 is a view of a reusable breakaway accessory keeper in accordance with another example embodiment of the disclosed concept;

FIG. 8 is a view of the bottom of the reusable breakaway accessory keeper of FIG. 7;

FIG. 9 is a side view of the reusable breakaway accessory keeper of FIG. 7; and

FIG. 10 is a view of a harness including the reusable breakaway accessory keeper of FIG. 7.

### DETAILED DESCRIPTION OF THE INVENTION

Directional phrases used herein, such as, for example, left, right, front, back, top, bottom and derivatives thereof, relate to the orientation of the elements shown in the drawings and are not limiting upon the claims unless expressly recited therein.

As employed herein, the statement that two or more parts are “coupled” together shall mean that the parts are joined together either directly or joined through one or more intermediate parts.

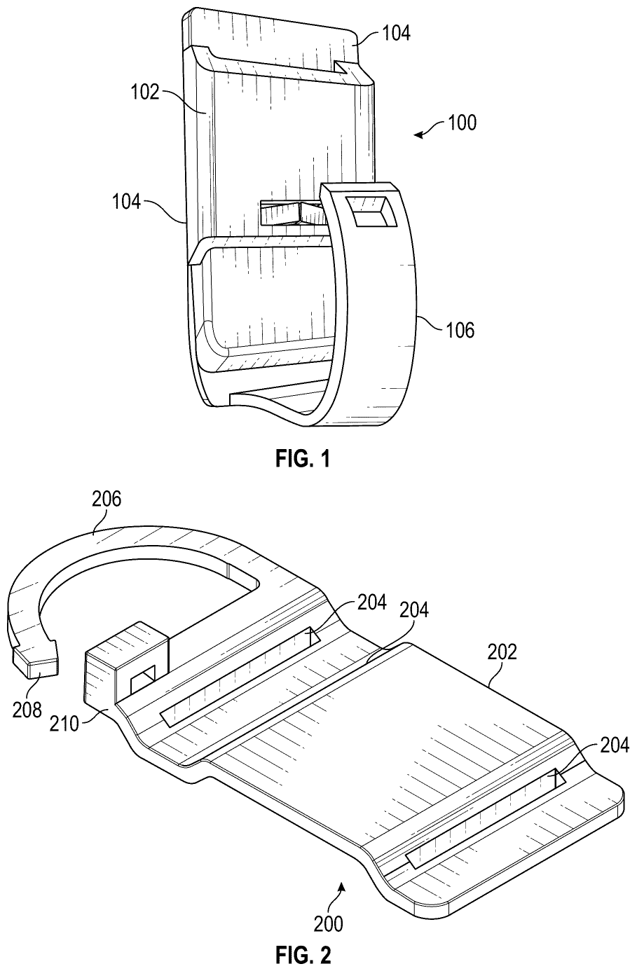

FIG. 1 is a view of a reusable breakaway accessory keeper 100 in accordance with an example embodiment of the disclosed concept. The reusable breakaway accessory keeper 100 includes a base 102 having slots 104 formed therein. The slots 104 are structured to allow webbing of a safety harness to pass through them to attach the reusable breakaway accessory keeper 100 to the safety harness. In some example embodiments, the webbing of the safety harness may be passed through the slots 104 during assembly of the safety harness. In some example embodiments, the reusable breakaway accessory keeper 100 may be attached to or at a chest strap of the safety harness. The base 102 may include a flat planar portion that is visible when the reusable breakaway accessory keeper 100 is attached to the safety harness. The flat planar portion is suitable for displaying graphics or text such as a logo or a name. In some example embodiments, the friction of the webbing through the slots 104 and against the base 102 assists with retaining the breakaway accessory keeper 100 in its place on the webbing as well as retains the webbing in its place on the safety harness.

The reusable breakaway accessory keeper 100 further includes a loop 106 attached to the base 102. The loop 106 is formed of an elongated piece that has one end extending from the base 102 and a second opposite end that is releasably attachable to the base 102. Attaching the second end of the loop 106 to the base 102 forms a closed loop. The second end of the loop 106 may be releasably attachable to the base 102 via an attachment mechanism, which may include, for example and without limitation, a hook formed at the second end of the loop 106 and a corresponding opening formed in the base 102. It will be appreciated that various different types of attachment mechanisms may be used to releasably attach the second end of the loop 106 to the base 102. For example and without limitation, the a hook formed in the base may attach to an opening formed in the second end of the loop 106. The attachment mechanism may be a snap fit connection. That is, the second end of the loop 106 may be deformable such that it deforms when pushed through the opening in the base 102 and snaps back into shape when through the opening. The attachment mechanism may be structured such that it is easier to push the second end of the loop 106 through the opening than it is to pull the second end of the loop 106 back through the opening. For example, the second end of the loop 106 may have a tapered shape that increases in cross-sectional area moving away from the second end of the loop 106. The attachment mechanism may be structured such that a pulling force of 120 lbs. will cause the second end of the loop 106 to be pulled back through the opening and detach from the base. In some example embodiments, the force may be smaller, such as for example and without limitation, the force may be any force in a range from 50-120 lbs. When the second end of the loop 106 is pulled back through the opening and detached from the base 102, the closed loop opens.

The closed loop formed when the second end of the loop 106 is attached to the base 102 is a suitable point to attach a lanyard of a fall protection system when the lanyard is not in use. This is useful to keep the lanyard out of the way and accessible when needed. It will be appreciated that other accessories may also be attached to the closed loop. When the second end of the loop 106 is pulled through the opening and detaches from the base, the closed loop opens, releasing the lanyard or other accessory attached to the closed loop. For example, if a lanyard becomes snagged on an object and is pulled with sufficient force, the closed loop will be pulled open (i.e., breakaway) and the lanyard will be released so as to prevent a worker wearing the harness from being impeded by the snag. Furthermore, after the closed loop is pulled open, the second end of the loop 106 may be pushed through the opening of the base 102 again to reform the closed loop. In this manner, the reusable breakaway accessory keeper 100 may be reused. Some prior accessory keepers included components that would break to release. In those types of accessory keepers, after an event causing the accessory keeper to breakaway, the accessory keeper could not be used again, and would need to be discarded and replaced.

In some example embodiments, the reusable breakaway accessory keeper 100 may be composed of a thermoplastic material such as, for example and without limitation, thermoplastic urethane (TPU). The material of the reusable breakaway accessory keeper 100 may be flexible. The flexibility of the material assists with passing the second end of the loop 106 through the opening in the base 102. That is, the second end of the loop 106 will be able to deform while passing through the opening. As such, the second end of the loop 106 may be repeatedly passed through the opening to open and close the loop 106 making the reusable breakaway accessory keeper 100 reusable.

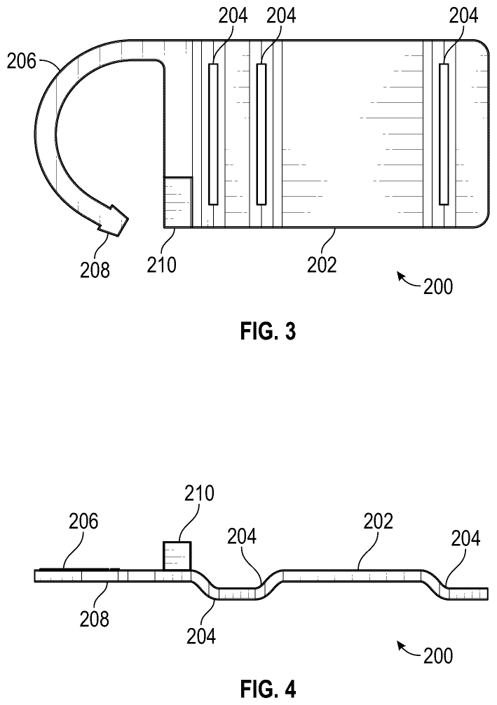

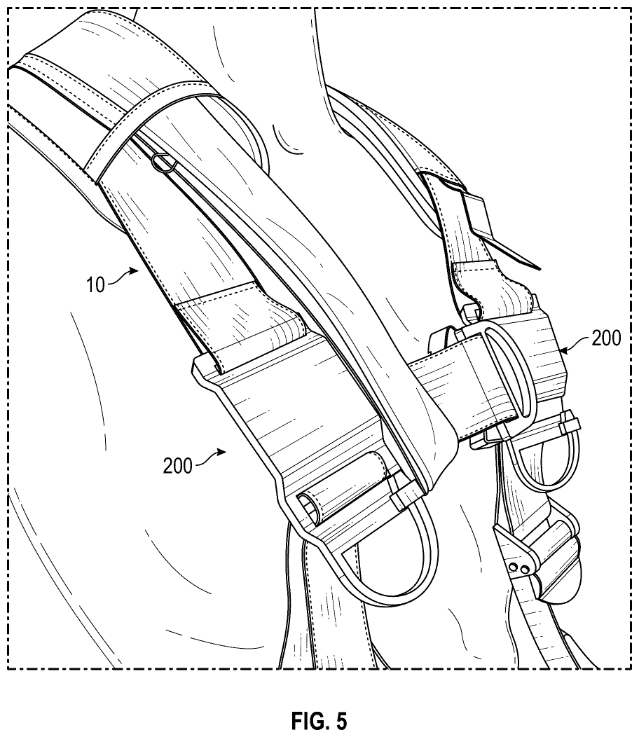

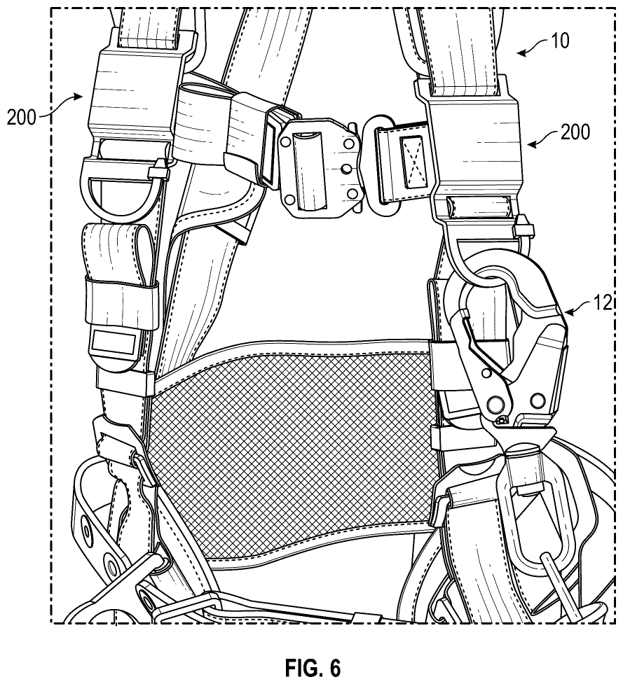

FIG. 2 is a view of a reusable breakaway accessory keeper 200 in accordance with another example embodiment of the disclosed concept. FIG. 3 is a top view of the reusable breakaway accessory keep 200 and FIG. 4 is a side view of the reusable breakaway accessory keeper 200. FIGS. 5 and 6 are views of a safety harness 10 including the reusable breakaway accessory keeper 200 of FIG. 2. The reusable breakaway accessory keeper 200 is similarly reusable as the reusable breakaway accessory keeper 100 of FIG. 1. The reusable breakaway accessory keeper 200 includes a base 202 having slots 204 formed therein. The number of slots 204 may be three in some example embodiments. The slots 204 are structured to receive webbing of the safety harness 10, as is shown in FIGS. 5 and 6. The webbing may be passed through the slots 204 to attach the reusable breakaway accessory keeper 200 to the webbing of the safety harness 10. The reusable breakaway accessory keeper 200 may be attached near or to a chest strap of the safety harness 10. The base 202 may have a flat planar area that is visible when the reusable breakaway accessory keeper 200 is attached to the safety harness 10. The flat planar area is suitable for display of graphics or text such as a logo or name. The base 202 may have a stepped design with the flat planar area in one plane and other planar areas offset in parallel planes. The base 202 may also have an end planar area adjacent a loop 206, coplanar with the flat planar area. The slots 204 may be formed in transition areas between the various planar areas of the base 202.

In an example embodiment, the base 202 includes a first planar area (shown on the right side of FIG. 4). The first planar area is offset from the plane of the flat planar area. A first transition area extends from the first planar area to the flat planar area. A first one of the slots 204 is formed in the first transition area. The first transition joins the first planar area with the flat planar area. A second transition area extends from the flat planar area and joins the flat planar area with a second planar area. The second planar area may be coplanar with the first planar area. A second one of the slots 204 is formed in the second transition area. A third transition area extends from the second planar area and joins the second planar area with the end planar area. A third one of the slots 204 is formed in the third transition area.

When attaching the breakaway accessory keeper 200 to webbing, in one example embodiment shown in FIG. 6, the webbing is passed through the first one of the slots 204 from a top side to a bottom side of the slot 204. The webbing then passes beneath the flat planar area and is passed through the second one of the slot 204 from a bottom side to a top side of the slot 204. The webbing then passes over the second planar area and is passed through the third one of the slots 204 from to top side to a bottom side of the slot 204. Friction between the webbing and the slots 204 assists with maintaining the breakaway accessory keeper 200 in position on the webbing. Additionally, the flat planar area is visible when the breakaway accessory keeper 200 is installed on the webbing. In another example embodiment shown in FIG. 5, a first section of webbing may be passed though the first one of the slots 204 and then stitched back onto itself to attach the first second of webbing to the reusable breakaway accessory keeper 200. A second section of webbing is passed through the second and third ones of the slots 204 and then is stitched back onto itself to attach the second section of webbing to the reusable breakaway accessory keeper 200. In this manner, the reusable breakaway accessory keeper 200 joins the first and second sections of webbing.

A first end of the loop 206 may extend from the end planar area of the base 202. In some example embodiments, the loop 206 may be substantially coplanar with the flat planar area of the base 202, but it will be appreciated that the loop 206 may be offset from the flat planar area. The loop 206 is arcuate and curves such that a second end of the loop 206 points toward the base 202. The second end of the loop 206 is releasably attachable to the base 202. The loop 206 may be releasably attachable to the base 202 via an attachment mechanism. The attachment mechanism may include a hook 208 disposed at the second end of the loop 206 and an opening 210 disposed at the end planar area of the base 202. The hook 208 is structured to form a snap fit with the opening 210 by pressing the hook 208 through the opening 210. Pulling on the loop 206 with sufficient force will cause the hook 208 to be pulled back through the opening 210. In this manner, the loop 206 can be attached to the base to form a closed loop suitable for attaching a lanyard or other accessory to. The loop 206 can be released by pulling the loop 206 with sufficient force to open the loop 206 and release any lanyard or other accessory attached to the closed loop. In some example embodiments, the force may be 120 lbs., but it will be appreciated that the force may be any force in a range from 50-120 lbs. While one example of an attachment mechanism is described, it will be appreciated that other types of attachment mechanisms may be employed to releasably attach the second end of the loop 206 to the base 202. For example and without limitation, the base 202 may include a hook that is received by an opening in the second end of the loop 206 to releasably attach the second end of the loop 206 to the base 202. It will be appreciated that other attachment mechanisms may be employed such as, for example and without limitation, any suitable type of snap fit mechanism.

In some example embodiments, the reusable breakaway accessory keeper 200 may be composed of a thermoplastic material such as, for example and without limitation, TPU. The material of the reusable breakaway accessory keeper 200 may be flexible. The flexibility of the material assists with passing the hook 208 through the opening 210. That is, the hook 208 will be able to deform while passing through the opening 210. As such, the hook 208 may be repeatedly passed through the opening to open and close the loop 206 making the reusable breakaway accessory keeper 200 reusable.

FIGS. 5 and 6 are views of the reusable breakaway accessory keeper 200 attached to a harness 10. As shown in FIGS. 5 and 6, webbing of the harness 10 is passed through slots 204 of the reusable breakaway accessory keeper 200 to attach the reusable breakaway accessory keeper 200 to the harness 10. As shown in FIGS. 5 and 6, the flat planar area of the reusable breakaway accessory keeper 200 is visible when the reusable breakaway accessory keeper 200 is attached to the harness 10. In some example embodiments, the reusable breakaway accessory keeper 200 is oriented such that the loop 206 is at the bottom of the reusable breakaway accessory keeper 200 when the reusable breakaway accessory keeper 200 is attached to the harness 10, as is shown in FIGS. 5 and 6. Such an orientation can make it more convenient to attach a lanyard or other accessory to the reusable breakaway accessory keeper 200. For example, as shown in FIG. 6, the hook 12 of a lanyard is attached to the reusable breakaway accessory keeper 200. It will be appreciated, though, that the reusable breakaway accessory keeper 200 may be attached in different orientations. In FIGS. 5 and 6, the reusable breakaway accessory keeper 200 is attached to a should strap of the harness 10 proximate the chest strap. This attachment location can be convenient for attaching a lanyard or other accessory to the reusable breakaway accessory keeper 200 because the location is easily accessible to the wearer of the harness 10. However, it will be appreciated that the reusable breakaway accessory keeper 200 may be attached at different locations on the harness 10 without departing from the scope of the disclosed concept. For example and without limitation, the reusable breakaway accessory keeper 200 may be attached to the chest strap, to a leg strap, or to other straps of the harness 10. It will also be appreciated that any number of reusable breakaway accessory keepers 200 may be attached to the harness 10. In the examples shown in FIGS. 5 and 6, two reusable breakaway accessory keepers 200 are attached to the harness 10. However, it will be appreciated that the example of two reusable breakaway accessory keepers 200 is non-limiting and any number of reusable breakaway accessory keepers 200 may be attached to the harness 10.

In some example embodiments, the base 202, the loop 206, and the attachment mechanism to releasably attach the second end of the loop 206 to the base 202 are formed together as a single structure. As used herein, parts formed together as a single structure means that the parts are formed together as a single piece of material. For example, the various parts of a molded object may be considered to be formed together as a single structure because all parts of the molded object are part of the same single piece of material and do not need to be joined or fastened together. However, it will also be appreciated that various components of the reusable breakaway accessory keeper 200 may be formed as separate structures that are joined together.

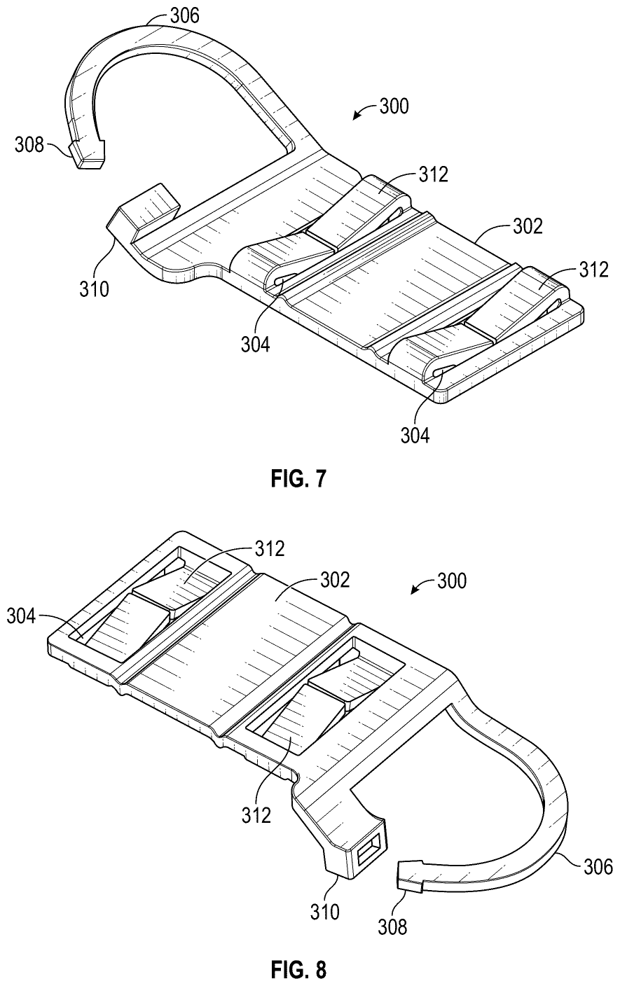

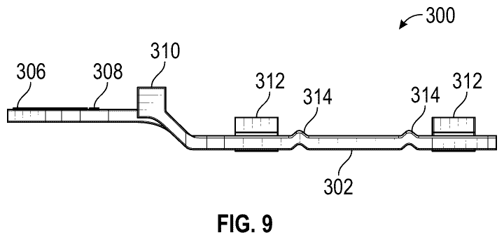

FIG. 7 is a view of a reusable breakaway accessory keeper 300 in accordance with another example embodiment of the disclosed concept. FIG. 8 is a view of the bottom side of the reusable breakaway accessory keeper 300 and FIG. 9 is a side view of the reusable breakaway accessory keeper 300. The reusable breakaway accessory keeper 300 is reusable similar to the reusable breakaway accessory keepers 100,200 of FIGS. 1 and 2. The reusable breakaway accessory keeper 300 includes a loop 306, hook 308, and opening 310 similar to the loop 206, hook 208, and opening 210 of the reusable breakaway accessory keeper 200 of FIG. 2. For economy of disclosure, repeated description of these elements is omitted.

The reusable breakaway accessory keeper 300 includes a base 302 having slots 304. Tabs 312 are disposed over the slots 304. There are two tabs 312 corresponding to each slot 304. The two tabs 312 are attached at opposite ends of the slot 304 and each extend inwardly to a central point of the slot 304. The tabs 312 are shaped such that they extend upwardly from the base 302 at the edge of the slot 304 and the slope downwardly toward the base 302 along the length of the tab 312 such that the ends of the tabs 312 at the central point of the slot 304 are disposed inside the slot 304. Webbing may be pressed through gaps between the tabs 312. The tabs 312, which slope downwardly into the slots 304, will interfere with the webbing and press the webbing downward into the slot 304 create friction on the webbing to hold the webbing in place. The tabs 312 are composed of a flexible materials such as, for example and without limitation, a thermoplastic material such as TPU. To attach the reusable breakaway accessory keeper 300 to webbing of a harness, a portion of the webbing can be pressed through the gaps between the tabs 312. As the webbing is pressed, the tabs 312 will bend, expanding the gap between the two tabs 312 associated with the slot 304. The webbing is pressed through the gap until it passes through the gap and is disposed between the tabs 312 and the base 302. When pressure is released, the tabs 312 will snap back to their normal shape and will hold the webbing against the base 302 with a friction fit.

Protrusions 314 are formed in the base 302 adjacent to the slots 304 in an area between the slots 304. The protrusions 314 extend away from the base 302. When the reusable breakaway accessory keeper 300 is attached to webbing, the webbing will pass over the protrusions 314 in the area between the slots 304. That is, the tabs 312 will press downward on the webbing while the protrusions 314 will push upward on the webbing in the area between the slots 304. This contact in opposite direction enhances the friction between the reusable breakaway accessory keeper 300 and the webbing and assists with retaining the reusable breakaway accessory keeper 300 in place on the webbing.

The reusable breakaway accessory keepers 100,200 of FIGS. 1 and 2 will often need to be attached to webbing of a safety harness at the time the safety harness is attached because the webbing needs to pass through the slots 104,204 of those reusable breakaway accessory keepers 100,200. The reusable breakaway accessory keeper 300 of FIG. 7 can easily be attached to existing webbing because a portion of the webbing only needs to be pressed through the gaps in the tabs 312.

It will be appreciated that the reusable breakaway accessory keeper 300 may be attached to webbing at any suitable location on a harness. For example, the reusable breakaway accessory keeper 300 may be attached to shoulder straps proximate a chest trap similar to where the reusable breakaway accessory keeper 200 is attached to the harness 10 in FIGS. 5 and 6. It will be appreciated that the reusable breakaway accessory keeper 300 may be attached at any other suitable location without departing from the scope of the disclosed concept.

In some example embodiments, the base 302, the loop 306, and the attachment mechanism to releasably attach the second end of the loop 306 to the base 302 are formed together as a single structure. In some example embodiments, the tabs 312 may also be formed as part of the same single structure. However, it will also be appreciated that various components of the reusable breakaway accessory keeper 300 may be formed as separate structures that are joined together.

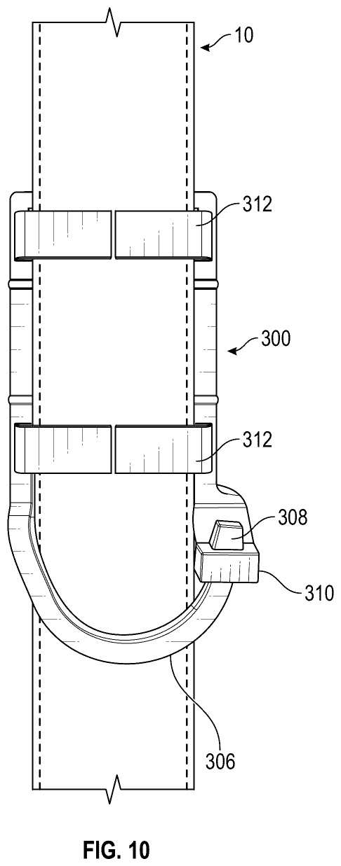

FIG. 10 is a view of the reusable breakaway accessory keeper 300 attached to a harness 10. As shown in FIG. 10, webbing of the harness 10 is disposed between the tabs 312 and the base 302 of the reusable breakaway accessory keeper 300. The angle of the tabs 312 press the webbing of the harness 10 into the slots 304 and against the protrusion 314 creating a friction fit which will retain the reusable breakaway accessory keeper 300 in position on the webbing. The install the breakaway accessory keeper 300 on the webbing, the webbing is pressed through the gaps between the tabs 312. The webbing may be turned sideways or folded to assist with pressing it through the gaps between the tabs 312. Once the webbing is though the gaps between the tabs 312, the webbing may be flattened so that it sits flush against the base 302 of the reusable breakaway accessory keeper 312. To detach the reusable breakaway accessory keeper 312 from the webbing, the webbing is passed back through the gaps in the tabs 312. In this manner, the reusable breakaway accessory keeper 300 may be easily attached and detached from webbing of a harness 10. The reusable breakaway accessory keeper 300 may be attached to a should strap of the harness 10 proximate the chest strap or any other location on the harness 10. It will also be appreciated that any number of reusable breakaway accessory keepers 300 may be attached to the harness 10.

While specific embodiments of the invention have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of disclosed concept which is to be given the full breadth of the claims appended and any and all equivalents thereof.

What is claimed is:

1. A reusable breakaway accessory keeper comprising:
a base structured to attach to webbing;
a loop having a first end extending from the base; and
an attachment mechanism structured to releasably attach a second end of the loop to the base,
wherein the loop is structured to form a closed loop when the second end of the loop is attached to the base and to open the closed loop when the second end of the loop is released from the base.

2. The reusable breakaway accessory keeper of claim 1, wherein the attachment mechanism includes a hook disposed at the second end of the loop and an opening formed in the base, and wherein the attachment mechanism is structured to attach the second end of the loop to the base when the hook is passed through the opening.

3. The reusable breakaway accessory keeper of claim 1, wherein the hook is composed of a flexible material, wherein the hook is structured to deform when passing through the opening, and wherein the hook is structured to return to a normal shape after passing through the opening.

4. The reusable breakaway accessory keeper of claim 1, wherein the attachment mechanism is structured to form a snap fit between the second end of the loop and the base when the second end of the loop is attached to the base.

5. The reusable breakaway accessory keeper of claim 1, wherein a force to release the second end of the loop from the base is greater than a force to attach the second end of the loop to the base.

6. The reusable breakaway accessory keeper of claim 5, wherein the force to release the second end of the loop from the base is at least 50 lbs.

7. The reusable breakaway accessory keeper of claim 6, wherein the force to release the second end of the loop from the base is within a range of 50-120 lbs.

8. The reusable breakaway accessory keeper of claim 1, wherein the base includes a number of slots formed therein and structured to receive the webbing to attach the base to the webbing.

9. The reusable breakaway accessory keeper of claim 8, wherein the base includes a first planar area disposed in a first plane and a second planar area disposed in a second plane, wherein the base includes a first transition area connecting the first planar area and the second planar area, and wherein a first one of the number of slots is disposed in the first transition area.

10. The reusable breakaway accessory keeper of claim 9, wherein the base includes a third planar area disposed in the first plane and a second transition area connecting the second planar area and the third planar area, wherein a second one of the number of slots is disposed in the second transition area, wherein the base includes a fourth planar area disposed in the second plane and a third transition area connecting the third planar area and the fourth planar area, and wherein a third one of the number of slots is disposed in the third transition area.

11. The reusable breakaway accessory keeper of claim 1, further comprising:
a number of slots formed in the base;
a first pair of tabs corresponding to a first one of the number slots, wherein the first pair of tabs each have a first end disposed at opposite edges of the first one of the number of slots and a second end disposed at a central point of the first one of the number of slots, and
wherein the first pair of tabs are composed of flexible material and the second ends of the first pair of tabs are structured to separate and form a gap when the second ends of the first pair of tabs are pressed.

12. The reusable breakaway accessory keeper of claim 11, further comprising:
a second pair of tabs corresponding to a second one of the number slots, wherein the second pair of tabs each have a first end disposed at opposite edges of the second one of the number of slots and a second end disposed at a central point of the second one of the number of slots, and
wherein the second pair of tabs are composed of flexible material and the second ends of the second pair of tabs are structured to separate and form a gap when the second ends of the second pair of tabs are pressed.

13. The reusable breakaway accessory keeper of claim 12, wherein the base includes a number of protrusions extending from the base in an area between the first one of the number of slots and the second one of the number of slots.

14. The reusable breakaway accessory keeper of claim 1, wherein the reusable breakaway accessory keeper is composed of a flexible material.

15. The reusable breakaway accessory keeper of claim 14, wherein the reusable breakaway accessory keeper is composed of thermoplastic urethane.

16. A reusable breakaway accessory keeper comprising:
a base structured to attach to webbing;
a loop having a first end extending from the base; and
an attachment mechanism structured to releasably attach a second end of the loop to the base,
wherein the base, the loop, and the attachment mechanism are formed together as a single structure.

17. The reusable breakaway accessory keeper of claim 16, wherein a number of slots are formed in the base and are structured to receive the webbing to attach the base to the webbing.

18. The reusable breakaway accessory keeper of claim 16, further comprising:
a number of slots formed in the base; and
a first pair of tabs corresponding to a first one of the number slots, wherein the first pair of tabs each have a first end disposed at opposite edges of the first one of the number of slots and a second end disposed at a central point of the first one of the number of slots, and
wherein the first pair of tabs are composed of flexible material and the second ends of the first pair of tabs are structured to separate and form a gap when the second ends of the first pair of tabs are pressed,
wherein the first pair of tabs are formed together with the base, the loop, and the attachment mechanism as a single structure.

19. The reusable breakaway accessory keeper of claim 16, wherein the base, the loop, and the attachment mechanism are composed of a flexible material.

20. A safety harness comprising:
webbing;
a reusable breakaway accessory keeper attached to the webbing, the reusable breakaway accessory keeper comprising:
a base structured to attach to the webbing;
a loop having a first end extending from the base; and
an attachment mechanism structured to releasably attach a second end of the loop to the base,
wherein the loop is structured to form a closed loop when the second end of the loop is attached to the base and to open the closed loop when the second end of the loop is released from the base.
